(19) United States
(12) Patent Application Publication
(10) Pub. No.: US 2024/0377853 A1
(43) Pub. Date: Nov. 14, 2024

(54) Power-Efficient Clocking and Clock Shaping

(71) Applicant: Expedera, Inc., Santa Clara, CA (US)

(72) Inventors: Sharad Chole, San Jose, CA (US); Shang-Tse Chuang, Los Altos, CA (US); Siyad Ma, Palo Alto, CA (US); Philippe Sarrazin, Campbell, CA (US)

(21) Appl. No.: 18/315,074

(22) Filed: May 10, 2023

(51) Int. Cl. G06F 1/04

(52) U.S. Cl. CPC G06F 1/04

(57) ABSTRACT

A power-efficient and clock-shaping clock structure for a digital semiconductor device. The device can include an array of logic blocks. A root-column clock trace is coupled to column-clock traces extending along each column of the array. The clock traces feed the logic block at evenly spaced points to control the delay time for the execution of the logic blocks. The root-column clock trace is fed a clock from a single endpoint that result in a propagation wave of logic blocks execution. The clock structure can include row-clock traces placed across the array rows and coupled to a root-row clock trace. Each logic block can receive a clock from the intersection of the column-clock trace and the row-clock trace. A clock input at a single point where the root-column clock trace and root-row clock trace meet.

### CROSS-REFERENCE TO RELATED APPLICATIONS

None.

### TECHNICAL FIELD

The present application relates to the field of clocking and clocking structures in integrated circuits. In particular, but not by way of limitation, the present invention discloses structures and systems for power-efficient clocking to best accommodate the data flow through a chip and clock shaping to compensate for OCV (on-chip variability) pessimism in integrated circuit applications.

### BACKGROUND

It should not be assumed that any of the approaches described in this section qualify as prior art merely by virtue of their inclusion in this section.

In developing and manufacturing a digital integrated circuit (a chip), the architecture paths affect circuit performance, power utilization of a circuit, clocking speed, the area required on a chip, and thus the wafer yield. In a typical chip design, the power requirement of the clocking structure typically ranges between ten to twenty-five percent of the clock's power requirement for sub-Gigahertz clocking speed. However, the clock's power requirement can rise up to forty-five percent of the chip's power requirement when operating at the Gigahertz clock speed. What is needed is a clocking architecture that is more scalable, uses less power, efficiently uses a wafer's utilization by avoiding wasted chip area in large system designs, and does not require large numbers of manual placement of clock buffers to compensate for OCV.

### SUMMARY

This summary is provided to introduce a selection of concepts in a simplified form that is further described below in the Detailed Description of Example Embodiments. This summary is not intended to identify key features or essential features of the claimed subject matter, nor is it intended to be used as an aid in determining the scope of the claimed subject matter.

According to one embodiment, the present disclosure is directed to a structure and method for power-efficient clocking and clock shaping for digital semiconductors. The clocking structure includes a semiconductor chip having an array comprised of rows and columns of logic blocks or IP blocks. Further, the present disclosure can be used within a subset of a chip design where the design subset includes rows and columns of logic blocks. Additionally, the clocking architecture can be part of a hierarchy of logic subsystems.

A root-clock trace is placed substantially parallel to and along one end of the array columns. A plurality of column-clock traces coupled to the root-clock trace and extending along each array column provides a clock path to each logic block. Clock buffers are placed in each logic block to regenerate a clock signal on the associated column-clock trace. Further, the clock buffers or flip-flops can be put along each column-clock trace to provide the required setup and hold time for input and output lines going from one logic block on the clock path to the next and adjacent logic block along the logic path.

In another aspect of the invention, a method for routing clock traces for an array of logic blocks on a semiconductor chip having a data flow path is shown and described. The method includes determining a data path for each column of logic blocks in the array of logic blocks. A column-clock trace is routed for each column such that the path substantially follows the data path of each array column. A clock buffer in each logic block is added and configured to regenerate a clock signal on the associated column-clock trace. Delay buffers can be added to the clock trace to provide the required setup and hold times between the input and output lines between adjacent logic blocks.

### BRIEF DESCRIPTION OF THE DRA WINGS

Exemplary embodiments are illustrated by way of example and not limited by the figures of the accompanying drawings, in which like references indicate similar elements.

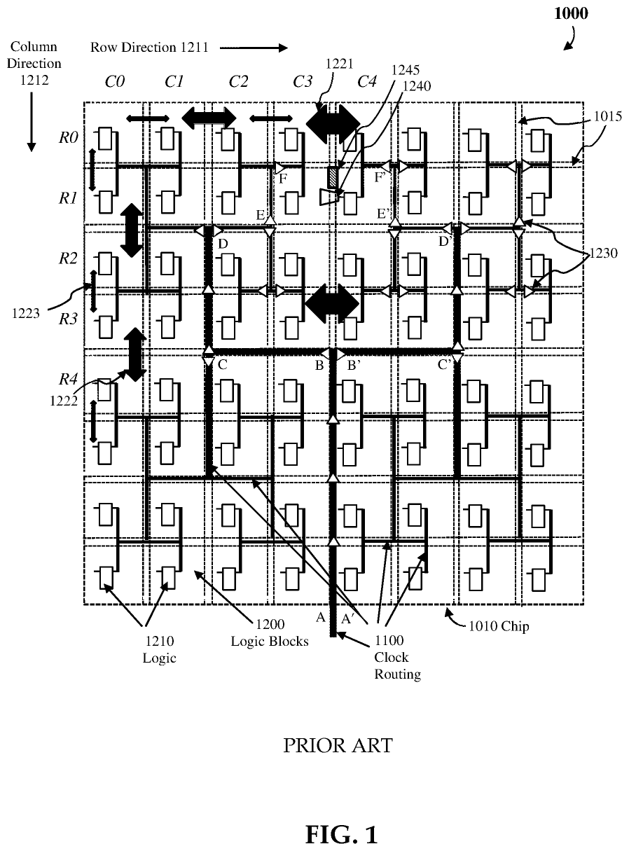

FIG. 1 is a prior art block diagram of a chip with an array of blocks of logic cells and clock traces in an “H” pattern.

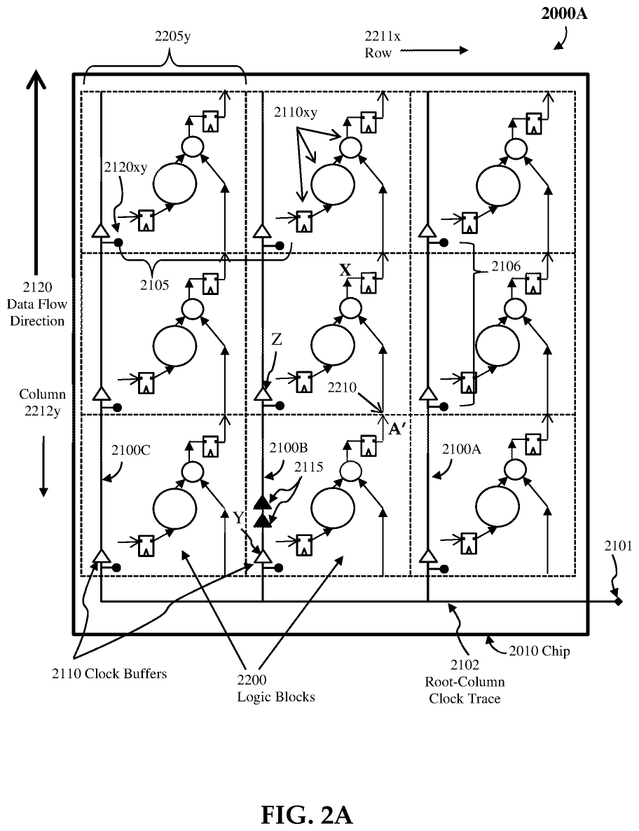

FIG. 2A is a diagram of one clock layout according to one embodiment with a root clock source.

FIG. 2B is a diagram of one clock layout according to one embodiment with a balanced clock source.

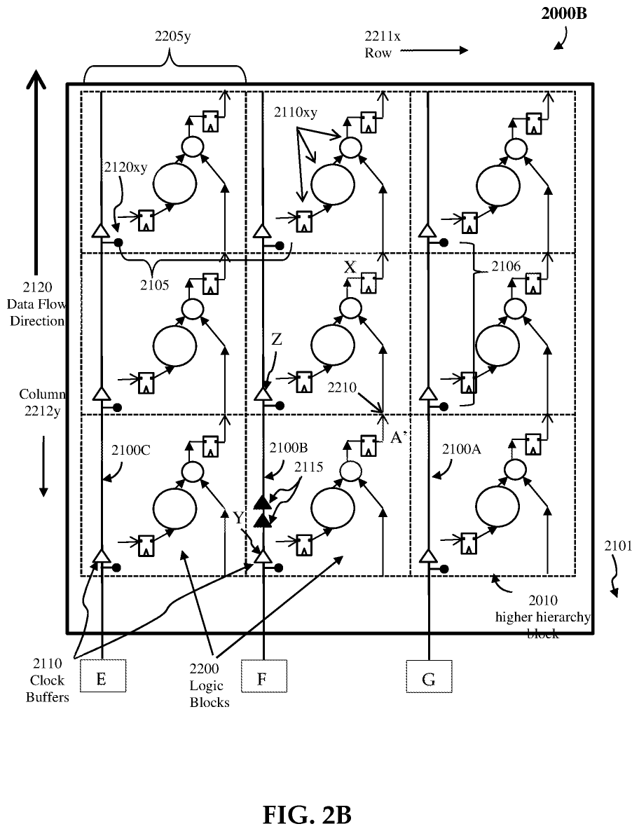

FIG. 3 is a timing diagram of the data and clock between two logic blocks.

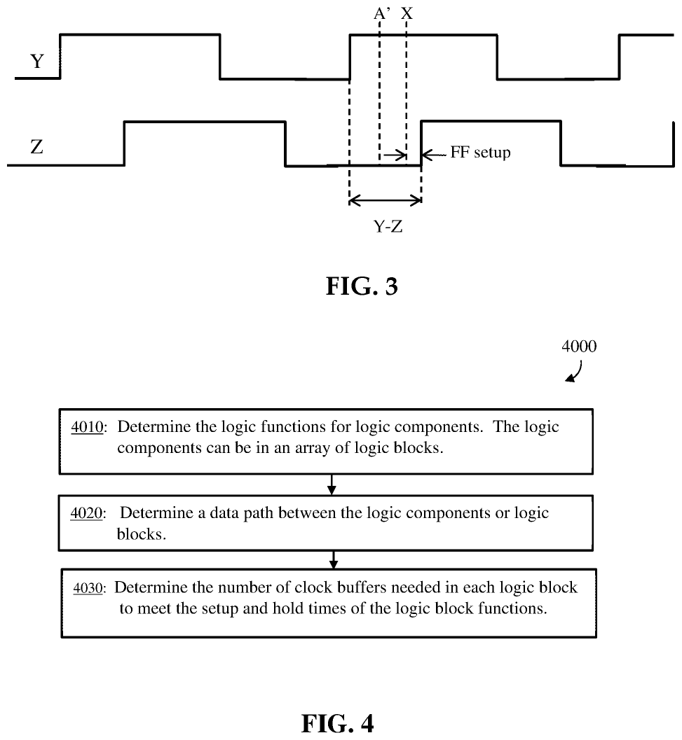

FIG. 4 is a flowchart for providing a power-efficient clocking structure.

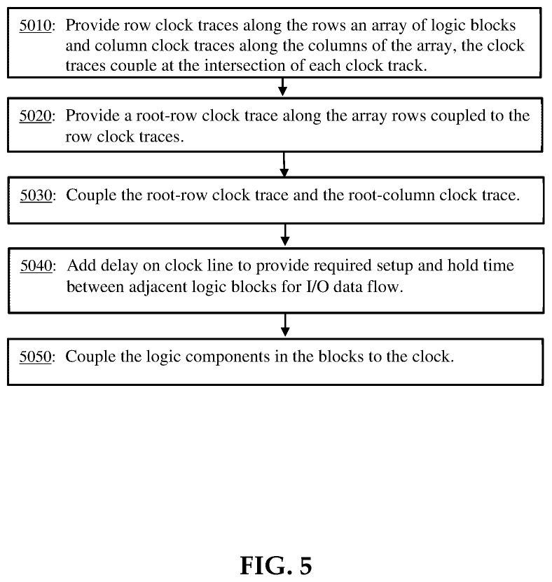

FIG. 5 is a flowchart for providing a power-efficient clocking structure and clock shaping for accommodating on-chip variations.

### DETAILED DESCRIPTION OF EXAMPLE EMBODIMENTS

The following detailed description includes references to the accompanying drawings, which are a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, functional, logical, and electrical changes can be made without departing from the scope of what is claimed. The following detailed description is, therefore, not to be taken in a limiting sense, and the scope is defined by the appended claims and their equivalents.

FIG. 1 illustrates one embodiment 1000 of prior art clock routing 1100 for a semiconductor block or chip 1010 configured with an array of logic blocks 1200 also referred to as IP blocks 1200. The prior art is discussed to highlight the differences and benefits of the applicant's invention. The position of the array of logic blocks 1200 can be referenced by rows (R0 . . . Rn) and columns (C0 . . . Cn). The row direction 1211 can be across the semiconductor block or chip 1010, and the column direction 1212 is down the semiconductor 1010. While not shown, the principles of this invention also applied where the chip has a hierarchy of logic blocks or other structures that require clocking. The traditional clock routing 1100, as shown, is configured in what is referred to as an “H” tree structure.

Along the clock routing 1100, clock buffers 1230 are shown. A clock buffer 1230 is provided at every point along the clock route 1100 where the clock signal needs to be regenerated to provide sufficient signal strength, shape, and timing. This clock buffer is shown as a triangle in FIG. 1. This clock buffer usually is placed in gaps 1015 found around logic blocks 1200. These clock buffers 1230 regenerate the clock signal that is attenuated by the loads along the clock route 1100. The clock buffer 1230 is not shown at every junction along the clock routing 1100, and all possible clock buffers are not shown for clarity of FIG. 1.

Between the logic blocks 1200 or IP blocks 1200 are gaps 1015. These gaps 1015 are required space to implement and place clock buffers 1230. Additionally, for the reasons described below, gaps 1015 are needed for adding delay buffers 1240 for fixing hold time input/output (I/O) flip-flops (FFs) for the I/O connections between logic blocks 1200. Not all I/O connections or delay buffers 1240 are shown in the gaps 1015 between all the logic blocks 1200 for clarity of FIG. 1.

### On-Chip Variation

Variations in transistors' characteristics as fabricated on silicon are known as OCV (On-Chip Variations). The reason for OCV is caused by the transistors on-chip not being alike in geometry, in their surroundings, and position with respect to a power supply. The variations are mainly caused by three factors: Process variation, Voltage variation, and Temperature variation.

For process variation, the process of fabrication diffusion, gate, gate oxide thickness, contact, via, metal, etc., the structures are not uniform throughout the wafer, even where layouts are identical because of the process variation. Thus, all transistors, metals, contacts, and via(s) are expected to have somewhat different characteristics.

Voltage variation is caused by how power is distributed to the transistors on the chip with the help of a power grid. The power grid has resistance and capacitance. Therefore, there is a voltage drop along the power grid. Those transistors situated close to the power source receive larger voltage as compared to other transistors. This causes delay variations across transistors.

Temperature variation on a chip causes variations in transistor characteristics. Thus, temperature variation caused by variations in power utilization and cooling will cause variations in transistor characteristics.

The “H” clock structure shown in FIG. 1 can incur a large amount of OVC depending on the data flow between logic blocks 1200. The arrows 1221, 1222, and 1223 have varying widths representing the varying OCV of the clock signal. The largest OCV is shown with the largest arrow 1221. The smallest OCV is shown by the smallest arrow 1223. If the data path was between blocks with a large OCV 1221, then the OCV might require that the data be transferred at a lower rate, thus a lower clocking speed and further require delay on the I/O lines between logic blocks 1200 for proper setup and hold times of I/O flip flops.

In an example, data flowing from the logic block 1200 on [R1, C3] to logic block [R1, C4], the clock path for logic block [R1 C3] follows the route A, B, C, D, E, F. The clock path for logic block [R1, C4] follows the path A, B, C′, D′, E′, and F′. Many of these two clock paths cross different parts of the chip and have different on-chip process variations, voltage variations, and temperature variations and thus are subject to OCV. Because these logic blocks 1200 are clocked at the same time, but the clock arrival to each FF may be different, the farther from the clock diversion point (B) to the logic block, the difference gets worse due to the OCV. The result is adding delay into the FF output path to satisfy the hold time requirement of input FF in adjacent blocks (left, right, above, and below).

On large chip designs, with more than sixteen logic blocks 1200, the number of I/O lines 1240 between the logic blocks 1200 can be numerous. While a single I/O line is shown in FIG. 1, the number of I/O lines can range from ten to over one thousand I/O lines. Ten or more delay buffers 1240 may be needed to generate the needed delay for hold times for data/control passing between logic blocks 1200 because of the OCV. These delay buffers 1240 are formed on the chip in the same gap between blocks like 1015 where the H clock tree is formed. Thus, for a chip with sixty-four logic blocks, the number of delay buffers can range from 6,400 to over 640,000. These delay buffers 1240 are too numerous to be manually placed and require tools for placement.

Another attribute of the “H” clocking structure is that all of the logic blocks 1200 are clocked at the same time. This simultaneous clocking causes large surges in the current, which can cause voltage dips, heating, and reliability problems.

In summary, the “H” clocking structure has the drawbacks of being affected by OCV, which can require slower clocking rates, tens to hundreds of thousands of extra delay elements 1245 on the I/O lines 1240 eating up power, gaps between logic blocks for the clock buffers 1230 and delay elements 12450, and increasing chip area (lower wafer yield, higher die cost), and increasing current surges when all the logic blocks execute.

### New Clocking Architecture

FIG. A2 illustrates one embodiment 2000A of the advantages of the inventive concept over the prior art. Of particular note is that there are no gaps between the logic blocks 2200 and thus improving a silicon wafer's yield, shortening the clock traces and thereby reducing power and increasing possible clock speeds. Further, the clock buffers are formed within the logic block thus eliminating the need for a gap between the logic blocks. Additionally, only additional clock buffers (additional delay), are needed on the clock line between the logic blocks and not hundreds or thousands of delay buffers on the I/O lines. Thus, hundred or many more thousands of delay buffers are eliminated saving chip space and power.

As illustrated, a semiconductor block or chip 2010 is comprised of adjacent logic blocks 2200 configured as an array. In another embodiment, the adjacent logic blocks 2200 can be a subpart or subcomponent of a larger semiconductor chip architecture. These logic blocks 2200 are arranged adjacent to each of the other logic blocks 2200 without a gap previously required by other clocking structures. Additionally, logic blocks 2200 can be part of a larger chip configuration. This arrangement saves silicon wafer space and reduces the length of the column-clock traces 2100A-C. Each logic block 2200 is configured with digital logic or other electronic components 2210xy formed within the block or chip 2010. The “x” and “y” represent the row and column of each logic block 2200. While the logic 2110xy within a logic block 2200 is shown to be identical, this logic 2110xy can vary between each logic block 2200. Further, while the logic blocks 2200 are shown to be squares, they can be rectangular shaped and of any size.

The clock for the logic 2110xy is provided from a trace tap 2120xy coupled to the column-clock traces 2100A-C. The column-clock traces 2100A-C are coupled to a root-column clock trace 2102. Each of the column-clock traces 2100A-C is routed across each block 2200 in the respective column 2205y. As shown, the clock signal travels in the same direction as the data path in each column. The root-column clock trace 2102 is placed substantially parallel to the array rows and at the bottom of the array or block or chip 2010. A clock source can be input at a single point 2101 to control the flow of the clock and the subsequent execution of the block logic 2110xy.

In another embodiment of the invention, as shown in FIG. 2B, root column clocks (E, F & G) can be driven by a balanced “H” clock tree or other clock-balanced methods. The source of the balanced “H” can be outside the block or chip 2010 from a hierarchical clock source. The hierarchical clock source can be part of a larger hierarchy of logic functions on a semiconductor chip or design. The direction that is considered a row or a column is arbitrary; therefore, the root-column clock 2102 can be a root-row clock trace (not shown) for clock traces (not shown) positioned along the rows. This configuration can be used if the data path is along the rows.

The column-clock traces can include delay buffers 2115 within a logic block 2200. The delays are inserted to allow a block logic to execute and generate output data 2210 to the next logic block along the data path and have sufficient hold time before the next logic block 2200 along a column-clock trace is clocked. While the I/O data 2210 is shown as a single connecting trace, it is typically one hundred or more lines. Note another beneficial aspect of the architecture is that OVC is not a factor when two blocks are adjacent to each other. The clock path is a short physical distance between adjacent blocks, and the OVC is minimal over these short distances. Furthermore, to adjust the timing between the execution of one logic block and the next block, only a few, one to three delay clock buffers are required to solve the hold time issues due to OCV. This is in sharp contrast to the “H” clock architecture, which may require thousands of delay elements for the I/O 2210 of each logic block.

Another advantage of the applicant's invention is having a root-column clock trace 2102 with column-clock traces 2100A-C placed along each column 2205y is that not all of the logic blocks 2200 are clocked at the same time. Because of the delay buffers 2115, the execution of the logic block next along the column-clock trace 2100A-C, is offset in time from the logic block earlier along the column-clock trace 2100A-C. This prevents a large current load that would occur if all of the logic blocks 2200 were clocked at the same time. The clocking of the logic blocks 2200 executes as a wave across the block or chip 2010. Each triangle 2110 represents a delay in the clock signal.

If delays are placed along the root-column clock trace (not shown), the chip or sub-block within a block or chip 2010 can be configured such that the logic block 2200 at the bottom right is the first to be clocked. Next, at about the same time, the clock reaches the logic block above and to the left of the bottom right logic block 2200. The clock progresses, and the execution of the logic block progresses as a wave along a diagonal of the block array, where the block logic 2210xy executes until the logic block in the upper left corner executes. Thus, the peak power or current required to execute the block logic 1120xy and current surges are minimized. If the clock source is configured as FIG. 2A, then the execution of the logic blocks progresses a wave. The wave starts at the bottom row and moves up row by row, along with a clock trace going from left to right or right to left or top to bottom, the power wave moves in the same direction as the data and clock trace.

Another aspect of the invention is the positioning of the trace taps 2120xy. A trace tap is where the clock signal is fed into the logic block. Preferably, these trace taps 2120xy are substantially equally spaced 2105 and 2106 along the column-clock traces 2100A-C and between the row-clock traces 2100A-C. The equal spacing provides for more consistent delays between the rows and columns, which results in a more predictable current demand by the executing logic blocks 2200. However, the other aspects of the invention are still applicable independent of the trace taps 2120xy location.

FIG. 3 is a timing chart of the clock between two points, Y and Z, on the column-clock trace 2100B and between adjacent logic blocks with respect to the input and output signals between the adjacent logic blocks. The “Y” clock signal is the clock earlier in the column-clock trace 2100B. The “Z” is the clock signal in the following logic block 2100.

A specific timing relationship between adjacent logic blocks needs to be met. The relationship:
A′ to X+FF setup+clock uncertainty needs to be <Y to Z
   The “Y” to “Z” time needs to meet the relationship:
Y to Z needs to be <1 clock cycle+Flip-Flop (FF) hold time−clock uncertainty.
   Below is the setup and hold requirements for the adjacent logic block receiving the I/O signals:
Setup requirement: Y to Z delay needs to be greater than A′-X+FF setup+clock uncertainty set up time.
Hold requirement: Y to Z delay needs to be smaller than one (1) clock cycle+FF hold time-clock uncertainty.
   Note: It is easy to adjust the Y-Z timing by adding or subtracting clock buffer(s) to meet the above requirement.

Clock uncertainty is the time difference between the arrivals of clock signals at registers in one clock domain or between domains. In the case of the present invention, domains are adjacent logic blocks.

Referring to FIG. 4, a flowchart of a method 4000 providing a power-efficient clock structure is shown and described. In step 4010, the chip function for the logic block and logic components are determined. The chip function can be implemented in a number of logic blocks within an array. The mapping of the logic components can be implemented to operate within a column within an array or can cross rows.

In step 4020, a determination of the data flow path is generated. This data flow path can be along an array column, array row, or both.

In step 4030, a clock trace is provided to substantially follow the data path. The data path preferably follows a column or row but can have any other data flow path between logic blocks with the array.

In step 4040, the number of clock buffers needed in each logic block to meet the hold times of the logic block functions is determined with the minimum effect on setup time.

Referring to FIG. 5, a flowchart of a method 5000 of providing a power-efficient clock structure that minimizes OCV is shown and described for a semiconduction with an array of logic blocks. In step 5010, the clock traces for each row and column of the logic array are provided. These form the row clock traces and the column clock traces. The row clock trace and column clock trace are connected where they cross. Preferably, the row clock trace and column clock trace are uniformly positioned along the rows and columns of the array to minimize the clock variances. However, variances in the clock positions are contemplated in this invention.

In step 5030, a root-column clock trace is provided along one side of the logic block array perpendicular to the root-row clock trace. The root-column clock trace is connected to the column clock traces. In another embodiment, the “H” clock tree or balance clock is connected to the column clock traces and depicted in FIG. 2B.

In step 5040, a tap from the row clock traces, and column clock traces are provided. Preferably, these tap points are at the intersection of the row and column clock traces. However, other points are contemplated, including a tap point that is placed along the row clock trace or the column clock trace.

In step 5050, the number of clock buffers needed in each logic block to meet the hold times of the logic block functions is determined.

In step 5060, the clock is coupled to the logic block components. Typically, this coupling is done at the tap point:

The corresponding structures, materials, acts, and equivalents of all means or step plus function elements in the claims below are intended to include any structure, material, or act for performing the function in combination with other claimed elements as specifically claimed. The description of the present technology has been presented for the purposes of illustration and description but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application and to enable others of ordinary skill in the art to understand the present technology for various embodiments with various modifications as are suited to the particular use contemplated.

Aspects of the present technology are described above with reference to flowchart illustrations and/or block diagrams of methods and apparatus (systems) according to embodiments of the present technology.

The flowchart and block diagrams in the Figures illustrate the architecture, functionality, and operation of possible implementations of systems, methods, and computer program products according to various embodiments of the present technology. In this regard, each block in the flowchart or block diagrams may represent a module, section, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or combinations of special purpose hardware.

In the following description, for purposes of explanation and not limitation, specific details are set forth, such as particular embodiments, procedures, techniques, etc., in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment,” “in an embodiment,” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms, and a plural term may include its singular form. Similarly, a hyphenated term (e.g., “on-demand”) may occasionally be interchangeably used with its non-hyphenated version (e.g., “on-demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a,” “an,” and “the” are intended to include the plural forms as well unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof.

It is noted that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purposes only and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

While various embodiments have been described above, it should be understood that they have been presented by way of example only and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A digital semiconductor clocking structure comprising:
a root-clock trace placed substantially perpendicular to one end of an array of logic blocks on one of a semiconductor chip or a logical sub-block within a semiconductor block or chip having a plurality of input and output lines between bordering logic blocks, the array of logic blocks having array columns and array rows;
a plurality of column-clock traces coupled to the root-clock trace and extending along each array column substantially in the direction of a data flow between the logic blocks, thereby providing a clock path; and
a clock buffer in each logic block and configured to regenerate a clock signal on the associated column-clock trace of the plurality of column-clock traces.

2. The digital semiconductor clocking structure of claim 1, wherein the bordering logic blocks are adjacent to each other.

3. The digital semiconductor clocking structure of claim 1, further comprising:
one or more delay buffers within a logic block and the one or more delay buffers are connected along at least one of the plurality of column-clock traces, thereby creating a clock delay.

4. The digital semiconductor clocking structure of claim 3, wherein the number of the one or more delay buffers is depends on the processes, area, temperature and voltage of the semiconductor chip.

5. The digital semiconductor clocking structure of claim 2, wherein the one or more delay buffers are configured to provide sufficient hold times on the input and output lines between adjacent logic blocks.

6. The digital semiconductor clocking structure of claim 3 wherein the clock delay is greater than the time for data to flow from the input of the adjacent logic block and the output of the adjacent logic blocks plus a flip-flop time plus a clock uncertainty time, and wherein the clock delay is less than one clock cycle plus the flip-flop hold time minus the clock uncertainty.

7. The digital semiconductor clocking structure of claim 5, wherein the number of input and output lines is greater than one-hundred.

8. The digital semiconductor clocking structure of claim 1, wherein the logic blocks form a data path along the column and the data path and the clock path are in the same direction.

9. The digital semiconductor clocking structure of claim 1, wherein the logic blocks form a data path along the column and the data path, and the clock path are in the opposite direction.

10. The digital semiconductor clocking structure of claim 1, wherein the root-clock trace has a single input from which a clock signal is input.

11. The digital semiconductor clocking structure of claim 1, wherein each logic block is coupled to the respective clock trace of the plurality of clock traces from a trace tap at substantially the same location within the logic block.

12. A digital semiconductor clocking structure comprising:
an array of logic blocks on one of a semiconductor chip or a logical sub-block within a semiconductor chip having a plurality of input and output lines between bordering logic blocks, the array of logic blocks having array columns and array rows;
a plurality of column-clock traces coupled to the root-clock trace and extending along each array column substantially in the direction of a data flow between the logic blocks, thereby providing a clock path; and
a clock buffer in each logic block and configured to regenerate a clock signal on the associated column-clock trace of the plurality of column-clock traces.

13. The digital semiconductor clocking structure of claim 12, wherein the column-clock traces coupled to one of an external “H” clock tree and a balanced clock.

14. A method for routing clock traces for an array of logic blocks on a semiconductor chip having a data flow path configured, the method comprising:
determining a data path for each column of logic blocks;
routing a column-clock trace for each column to substantially follow for each data path of each column; and
adding one or more clock buffer in each logic block configured to regenerate a clock signal on the associated column-clock trace.

15. The method for routing clock traces of claim 14, wherein the logic blocks are adjacent to each other.

16. The method for routing clock traces of claim 14, further comprising:
adding one or more delay buffers within a logic block and the one or more delay buffers are connected along at least one of the plurality of column-clock traces, thereby creating a clock delay between the logic block clock and an adjacent logic block.

17. The method for routing clock traces of claim 16, wherein the clock delay is greater than the time for data to flow from the input of the adjacent block and the output of the adjacent logic block plus a flip-flop time plus a clock uncertainty time, and wherein the clock delay is less than one clock cycle plus the flip-flop hold time minus the clock uncertainty.

18. The method for routing clock traces of claim 17, wherein the array of logic blocks have a input and output lines between adjacent logic blocks and wherein the number of input and output lines is greater than one-hundred.

19. The method for routing clock traces of claim 14, the method further comprising adding a row clock trace positioned substantially perpendicular to one end of the array of logic blocks on a semiconductor chip.

20. The method for routing clock traces of claim 19, wherein the root-clock trace has a single input from which a clock signal is input.

21. The method for routing clock traces of claim 14, wherein each logic block is coupled to the respective clock trace of the plurality of clock traces from a trace tap at substantially the same location within the logic block.
